(19) United States
(12) Patent Application Publication
(10) Pub. No.: US 2003/0206743 A1
(43) Pub. Date: Nov. 6, 2003

(54) Cross connecting device and optical communication system

(76) Inventor: Shigeyuki Yanagimachi, Tokyo (JP)

Correspondence Address: DICKSTEIN SHAPIRO MORIN & OSHINSKY LLP, Steven I. Weisburd, 41st Floor, 1177 Avenue of the Americas, New York, NY, 10036-2714, US

(21) Appl. No.: 10/330,503

(22) Filed: Dec. 26, 2002

(30) Foreign Application Priority Data
Dec. 28, 2001 (JP) 2001-398724

(51) Int. Cl. H04J 14/00; H04J 14/02

(52) U.S. Cl. 398/100

(57) ABSTRACT

A wavelength multiplexed signal transmitted through an inter-node transmission path is demultiplexed to a wavelength band by a first optical demultiplexer and after having its path changed by a first matrix switch, the obtained signal is again wavelength-multiplexed by a first optical multiplexer and then output to the inter-node transmission path. On the other hand, signals to be subjected to processing on a wavelength basis are demultiplexed on a wavelength basis by a second optical demultiplexer capable of demultiplexing an arbitrary wavelength band through a link and after having their paths changed by a second matrix switch, the obtained signals are again multiplexed to a wavelength band by a second optical multiplexer, subjected to the same processing as that of the above-described wavelength band and output to the inter-node transmission path.

### BACKGROUND OF THE INVENTION

1. Field of the Invention

The present invention relates to a cross connecting device and an optical communication system and, more particularly, to improvement in a cross connecting device which is for use in an optical communication system employing a wavelength multiplex method of wavelength-multiplexing an optical signal and transmitting the wavelength-multiplexed signal and which has a function of transmitting a wavelength multiplexed signal with its path switched to an adjacent node and a function of outputting the signal to a client.

2. Description of the Related Art

In recent years, because the widespread of high-performance computers to home use has enabled the Internet for transmitting a large amount of information and the like to be more frequently used and enabled a large volume of information contents such as films and moving pictures to be distributed to each home through communication, the amount of information flowing through a transmission path has been sharply increased. For increasing a capacity and a speed of a transmission path, an optical network system for transmitting optical signals is indispensable and therefore, its improvement is urgently demanded. Also, a WDM (wavelength division multiplexing) technique for communicating signals with different wavelengths multiplexed has been recently used to lead to a further increase in a communication capacity.

A transmission signal is delivered from a sender to a target receiver through a repeater system called a node provided within a communication network. In a node, a line transfer system called a cross connecting device for switching a connection of each path is provided and by controlling a connection mode of a matrix switch in the cross connecting device, a path between the sender and the receiver is connected.

One example of a conventional cross connecting device is shown in FIG. 12. Wavelength multiplexed signals applied through inter-node transmission paths 431 to 433 are demultiplexed on a wavelength basis by optical demultiplexers 451 to 453. The demultiplexed optical signals, after being subjected to waveform reproduction and wavelength conversion by an optical-electrical-optical transducer 41, are applied to a matrix switch 40 to have their paths changed. The matrix switch 40 is an optical space switch for changing a path of an optical signal. The optical signals whose paths have been switched have their wavelengths multiplexed again by optical multiplexers 461 to 463 and output through inter-node transmission paths 441 to 443. Part of the optical signals is connected to a client interface 42 side by the matrix switch 40 and distributed to each client.

As described in the foregoing, a method of demultiplexing a signal on a wavelength basis and switching its path needs as many ports of the matrix switch 40 as the number obtained by multiplying the number of wavelengths multiplexed by the number of inter-node transmission paths. Recent advancement of multiplexing techniques invites rapid increase in the number of wavelengths multiplexed from 80 to 160 and the number of necessary ports of the matrix switch 40 as well. Assume, for example, that to a certain node, ten 160-wavelength-multiplexed signals are transmitted, a matrix switch having 1600 ports is necessary. Such a large-scale optical matrix switch, however, is yet to be put into a practical use.

For the reduction of the number of ports of a matrix switch, a hierarchical cross connecting system is disclosed for cross-connecting a wavelength band as a bundle of a plurality of wavelengths on a wavelength basis. Out of wavelength multiplexed signals, by thus bundling signals bound for the same direction on a wavelength band basis and changing their paths in the lump, the scale of a matrix switch can be reduced more than by the method of demultiplexing all the signals on a wavelength basis and cross-connecting the same which is shown in FIG. 12. Operation of a cross connecting for changing a path on a wavelength band basis will be described with reference to FIG. 13.

Wavelength multiplexed signals applied through inter-node transmission paths 131 and 132 are demultiplexed to wavelength bands by first optical demultiplexers 151 and 152. The demultiplexed optical signals are applied to a first optical matrix switch 10 to have their paths switched. The first matrix switch 10 is an optical space switch for switching a path of an optical signal. The optical signals having their paths switched are again wavelength-multiplexed by first optical multiplexers 161 and 162 and output to inter-node transmission paths 141 and 142.

It is for example necessary to switch constituent wavelengths in two wavelength bands or resolve a wavelength band to be distributed at a node in question to a client and conduct path change on a wavelength basis. Next, a method of changing a path on a wavelength basis will be described. Provided at the input of the first matrix switch 10 are a plurality of add (insertion) ports and provided at the output are a plurality of drop (branch) ports. Connected to the drop ports are links 111 and 112 and among optical signals on a wavelength band basis which pass through the first matrix switch 10, a signal which needs to have its path changed on a wavelength basis passes through the links 111 and 112 and are then demultiplexed on a wavelength basis by second optical demultiplexers 171 and 172.

After having their wavelengths converted by an optical-electrical-optical transducer 51, the optical signals demultiplexed on a wavelength basis are applied to a second matrix switch 11 to have their paths switched. The second matrix switch 11 is an optical space switch for switching a path of an optical path. The optical signals having their paths switched are again multiplexed on a wavelength band basis by second optical multiplexers 181 and 182, which will pass through links 101 and 102 and connect to the add ports of the first matrix switch 10. By thus demultiplexing wavelength bands on a wavelength basis to change a path, constituent wavelengths in a wavelength band can be switched. In addition, a part of the optical signals is connected to a client interface 12 side by the second matrix switch 11 and then distributed to each client.

As described in the foregoing, it is possible in such a system to switch a path on a wavelength band basis by the first matrix switch 10 and switch a path on a wavelength basis by the second matrix switch 11.

The above-described conventional system has various problems as set forth below.

First problem is that a cross connecting device for changing a path on a wavelength band basis and a path on a wavelength basis will have many kinds of optical demultiplexers for demultiplexing a wavelength band to a signal of each wavelength, thereby increasing inventory costs. The reason is that although demultiplexing a wavelength multiplexed signal transmitted through an inter-node transmission path into wavelength bands results in generating a plurality of wavelength bands of different wavelength band zones, an optical demultiplexer for demultiplexing the wavelength bands on a wavelength basis has a wavelength band zone to be demultiplexed determined in advance and therefore for demultiplexing a plurality of different wavelength bands, numbers of kinds of demultiplexers are necessary.

Second problem is that because one cross connecting device is not capable of demultiplexing numbers of wavelength bands of the same wavelength band zone, network path setting is constrained. The reason is that since an optical demultiplexer has its demultiplexable wavelength band zone determined and for the purpose of avoiding scale-up of a cross connecting device, it is impossible to arrange numbers of optical demultiplexers of the same kind, when there arises a need of demultiplexing numbers of wavelength bands of the same wavelength band zone in one cross connecting device, optical demultiplexers corresponding thereto runs short.

Third problem is that numerous links are required between a matrix switch for switching a path on a wavelength band basis and a matrix switch for switching a path on a wavelength basis, resulting in increasing the scale of the matrix switch. The reason is that for demultiplexing an arbitrary wavelength band on a wavelength basis in a cross connecting device, even when wavelength bands to be demultiplexed on a wavelength basis concentrate on a specific wavelength band zone, they should be all demultiplexed, so that it is necessary to dispose a plurality of optical demultiplexers of the same kind, which results in requiring many links between optical matrix switches.

In a case, for example, where a multiplexed signal has 160 waves multiplexed and a wavelength band is composed of four waves, 40 kinds of wavelength bands of different wavelength band zones are generated and for demultiplexing a wavelength band of an arbitrary wavelength band zone, 40 kinds of optical demultiplexers are necessary. In addition, with a plurality of inter-node transmission paths connected to a cross connecting device, when there arises a need of demultiplexing wavelength bands of the same wavelength band zone, optical demultiplexers several times the number of the bands will be required to result in drastically increasing the number of ports of a matrix switch connected to the optical demultiplexers.

### SUMMARY OF THE INVENTION

An object of the present invention is to provide, at a node of an optical network for transmitting a wavelength multiplexed signal, a cross connecting device which can be realized in small scale even when the number of wavelengths multiplexed is increased and which has a high degree of freedom of path control, and an optical communication system therefor.

Another object of the present invention is to provide a cross connecting device enabling more reduction in the number of kinds of optical demultiplexers to be prepared than that attained by a method using a conventional optical demultiplexer for demultiplexing a wavelength band of a fixed wavelength band zone, thereby enabling inventory costs to be reduced, and an optical communication system therefor.

A further object of the present invention is to provide a cross connecting device capable of, even when in one cross connecting device, wavelength band zones of a wavelength band to be demultiplexed concentrate on the same wavelength band zone, demultiplexing all the wavelength bands, and an optical communication system therefor.

A still further object of the present invention is to provide a cross connecting device enabling reduction in the number of links between a first matrix switch and a second matrix switch, as well as enabling reduction in the scale of the first and the second matrix switches, thereby realizing down-sizing and cost-down of the device, and an optical communication system therefor.

According to the first aspect of the invention, a cross connecting device, comprises

a first matrix switch for conducting path change of an applied wavelength multiplexed signal on the basis of a plurality of wavelength bands,

a second matrix switch for switching a path of a part of switch outputs from the first matrix switch on a wavelength basis, and

an optical demultiplexer provided on a link connecting the first and second matrix switches and capable of demultiplexing an arbitrary wavelength band.

In the preferred construction, the cross connecting device further comprises a third matrix switch for switching a path of a node-through signal out of the wavelength multiplexed signal.

According to the second aspect of the invention, a cross connecting device in an optical communication system employing a wavelength multiplex transmission method of transmitting an optical signal with wavelengths multiplexed, comprises

a first optical demultiplexer for demultiplexing the wavelength multiplexed signal to a wavelength band composed of a plurality of wavelengths,

a first matrix switch for receiving input of the wavelength band demultiplexed by the first optical demultiplexer to conduct path switching,

a first optical multiplexer for multiplexing outputs of the first matrix switch and outputting the multiplexed signal,

a second optical demultiplexer for receiving the wavelength band of an arbitrary band zone branched from at least one of branch ports of the first matrix switch and demultiplexing the band to a signal of each wavelength,

a second matrix switch for receiving input of the signal of each wavelength demultiplexed by the second optical demultiplexer to conduct path switching, and

a second optical multiplexer for multiplexing outputs of the second matrix switch and sending out the multiplexed signal to at least one of insertion ports of the first matrix switch.

In the preferred construction, the cross connecting device further comprises an optical-electrical transducer provided at a stage succeeding to the second optical demultiplexer, and an electrical-optical transducer provided at a stage succeeding to the second matrix switch, wherein the second matrix switch is formed of an electric switch.

In another preferred construction, the cross connecting device further comprises a client interface for receiving an electric signal branched from at least one of branch ports of the second matrix switch and transmitting the same to a client, as well as receiving an electric signal from the client and transmitting the same to at least one of the insertion ports of the second matrix switch.

In another preferred construction, the cross connecting device further comprises an optical-electrical transducer for receiving the signal of each wavelength which is branched from at least one of branch ports of the second matrix switch to convert the signal to an electric signal, a client interface for transmitting the electric signal converted by the optical-electrical transducer to a client, as well as receiving an electric signal from the client, and an electrical-optical transducer for converting the electric signal received by the client interface into an optical signal and transmitting the converted signal to at least one of the insertion ports of the second matrix switch.

In another preferred construction, the electrical-optical transducer is formed of a variable-wavelength laser.

In another preferred construction, the cross connecting device further comprises an optical-electrical transducer for receiving the signal of each wavelength which is branched from at least one of branch ports of the second matrix switch to convert the signal to an electric signal, a client interface for transmitting the electric signal converted by the optical-electrical transducer to a client, as well as receiving an electric signal from the client, and an electrical-optical transducer for converting the electric signal received by the client interface into an optical signal and transmitting the converted signal to at least one of the insertion ports of the second matrix switch, wherein the electrical-optical transducer is formed of a variable-wavelength laser.

In another preferred construction, the cross connecting device further comprises a third optical demultiplexer for demultiplexing the wavelength multiplexed signal to a node-through signal and a signal to be subjected to processing on the basis of the wavelength band and the wavelength, a third matrix switch for receiving input of the node-through signal to conduct path switching, and a third optical multiplexer for multiplexing an output of the third matrix switch and an output of the first optical multiplexer.

In another preferred construction, the cross connecting device further comprises an optical-electrical transducer provided at a stage succeeding to the second optical demultiplexer, and an electrical-optical transducer provided at a stage succeeding to the second matrix switch, wherein the second matrix switch is formed of an electric switch, and further comprises a third optical demultiplexer for demultiplexing the wavelength multiplexed signal to a node-through signal and a signal to be subjected to processing on the basis of the wavelength band and the wavelength, a third matrix switch for receiving input of the node-through signal to conduct path switching, and a third optical multiplexer for multiplexing an output of the third matrix switch and an output of the first optical multiplexer.

In another preferred construction, the cross connecting device further comprises a client interface for receiving an electric signal branched from at least one of branch ports of the second matrix switch and transmitting the same to a client, as well as receiving an electric signal from the client and transmitting the same to at least one of the insertion ports of the second matrix switch, a third optical demultiplexer for demultiplexing the wavelength multiplexed signal to a node-through signal and a signal to be subjected to processing on the basis of the wavelength band and the wavelength, a third matrix switch for receiving input of the node-through signal to conduct path switching, and a third optical multiplexer for multiplexing an output of the third matrix switch and an output of the first optical multiplexer.

In another preferred construction, the cross connecting device further comprises an optical-electrical transducer for receiving the signal of each wavelength which is branched from at least one of branch ports of the second matrix switch to convert the signal to an electric signal, a client interface for transmitting the electric signal converted by the optical-electrical transducer to a client, as well as receiving an electric signal from the client, an electrical-optical transducer for converting the electric signal received by the client interface into an optical signal and transmitting the converted signal to at least one of the insertion ports of the second matrix switch, a third optical demultiplexer for demultiplexing the wavelength multiplexed signal to a node-through signal and a signal to be subjected to processing on the basis of the wavelength band and the wavelength, a third matrix switch for receiving input of the node-through signal to conduct path switching, and a third optical multiplexer for multiplexing an output of the third matrix switch and an output of the first optical multiplexer.

In another preferred construction, the first optical demultiplexer is structured such that the wavelength band satisfies that a wavelength band constituent wavelength interval≧a wavelength interval between adjacent wavelength bands×the number of wavelength bands, and the second optical demultiplexer is formed of a wavelength band pass filter having a transmission band width which is equivalent to the constituent wavelength interval.

In another preferred construction, the cross connecting device further comprises an optical-electrical transducer provided at a stage succeeding to the second optical demultiplexer, and an electrical-optical transducer provided at a stage succeeding to the second matrix switch, wherein the second matrix switch is formed of an electric switch, the first optical demultiplexer is structured such that the wavelength band satisfies that a wavelength band constituent wavelength interval≧a wavelength interval between adjacent wavelength bands×the number of wavelength bands, and the second optical demultiplexer is formed of a wavelength band pass filter having a transmission band width which is equivalent to the constituent wavelength interval.

In another preferred construction, the cross connecting device further comprises a client interface for receiving an electric signal branched from at least one of branch ports of the second matrix switch and transmitting the same to a client, as well as receiving an electric signal from the client and transmitting the same to at least one of the insertion ports of the second matrix switch, wherein the first optical demultiplexer is structured such that the wavelength band satisfies that a wavelength band constituent wavelength interval≧a wavelength interval between adjacent wavelength bands×the number of wavelength bands, and the second optical demultiplexer is formed of a wavelength band pass filter having a transmission band width which is equivalent to the constituent wavelength interval.

In another preferred construction, the cross connecting device further comprises an optical-electrical transducer for receiving the signal of each wavelength which is branched from at least one of branch ports of the second matrix switch to convert the signal to an electric signal, a client interface for transmitting the electric signal converted by the optical-electrical transducer to a client, as well as receiving an electric signal from the client, and an electrical-optical transducer for converting the electric signal received by the client interface into an optical signal and transmitting the converted signal to at least one of the insertion ports of the second matrix switch, wherein the first optical demultiplexer is structured such that the wavelength band satisfies that a wavelength band constituent wavelength interval≧a wavelength interval between adjacent wavelength bands×the number of wavelength bands, and the second optical demultiplexer is formed of a wavelength band pass filter having a transmission band width which is equivalent to the constituent wavelength interval.

In another preferred construction, the cross connecting device further comprises a third optical demultiplexer for demultiplexing the wavelength multiplexed signal to a node-through signal and a signal to be subjected to processing on the basis of the wavelength band and the wavelength, a third matrix switch for receiving input of the node-through signal to conduct path switching, and a third optical multiplexer for multiplexing an output of the third matrix switch and an output of the first optical multiplexer, wherein the first optical demultiplexer is structured such that the wavelength band satisfies that a wavelength band constituent wavelength interval≧a wavelength interval between adjacent wavelength bands×the number of wavelength bands, and the second optical demultiplexer is formed of a wavelength band pass filter having a transmission band width which is equivalent to the constituent wavelength interval.

In another preferred construction, the first optical demultiplexer is formed such that the wavelength band has an equal interval and the second optical demultiplexer is formed of such a filter making use of light diffraction as is represented by an arrayed-waveguide gratings whose central wavelength interval of a transmission band coincides with the interval of the wavelength band constituent wavelength and whose free spectral range coincides with the interval of the wavelength band.

In another preferred construction, the cross connecting device further comprises an optical-electrical transducer provided at a stage succeeding to the second optical demultiplexer, and an electrical-optical transducer provided at a stage succeeding to the second matrix switch, wherein the second matrix switch is formed of an electric switch, and the first optical demultiplexer is formed such that the wavelength band has an equal interval and the second optical demultiplexer is formed of such a filter making use of light diffraction as is represented by arrayed-waveguide gratings whose central wavelength interval of a transmission band coincides with the interval of the wavelength band constituent wavelength and whose free spectral range coincides with the interval of the wavelength band.

In another preferred construction, the cross connecting device further comprises a client interface for receiving an electric signal branched from at least one of branch ports of the second matrix switch and transmitting the same to a client, as well as receiving an electric signal from the client and transmitting the same to at least one of the insertion ports of the second matrix switch, wherein the first optical demultiplexer is formed such that the wavelength band has an equal interval and the second optical demultiplexer is formed of such a filter making use of light diffraction as is represented by arrayed-waveguide gratings whose central wavelength interval of a transmission band coincides with the interval of the wavelength band constituent wavelength and whose free spectral range coincides with the interval of the wavelength band.

In another preferred construction, the cross connecting device further comprises an optical-electrical transducer for receiving the signal of each wavelength which is branched from at least one of branch ports of the second matrix switch to convert the signal to an electric signal, a client interface for transmitting the electric signal converted by the optical-electrical transducer to a client, as well as receiving an electric signal from the client, and an electrical-optical transducer for converting the electric signal received by the client interface into an optical signal and transmitting the converted signal to at least one of the insertion ports of the second matrix switch, wherein the first optical demultiplexer is formed such that the wavelength band has an equal interval and the second optical demultiplexer is formed of such a filter making use of light diffraction as is represented by arrayed-waveguide gratings whose central wavelength interval of a transmission band coincides with the interval of the wavelength band constituent wavelength and whose free spectral range coincides with the interval of the wavelength band.

In another preferred construction, the cross connecting device further comprises a third optical demultiplexer for demultiplexing the wavelength multiplexed signal to a node-through signal and a signal to be subjected to processing on the basis of the wavelength band and the wavelength, a third matrix switch for receiving input of the node-through signal to conduct path switching, and a third optical multiplexer for multiplexing an output of the third matrix switch and an output of the first optical multiplexer, wherein the first optical demultiplexer is formed such that the wavelength band has an equal interval and the second optical demultiplexer is formed of such a filter making use of light diffraction as is represented by arrayed-waveguide gratings whose central wavelength interval of a transmission band coincides with the interval of the wavelength band constituent wavelength and whose free spectral range coincides with the interval of the wavelength band.

According to another aspect of the invention, an optical communication system, wherein a cross connecting device is applied to a node device,

the cross connecting device comprises a first matrix switch for conducting path change of an applied wavelength multiplexed signal on the basis of a plurality of wavelength bands, a second matrix switch for switching a path of a part of switch outputs from the first matrix switch on a wavelength basis, and an optical demultiplexer provided on a link connecting the first and second matrix switches and capable of demultiplexing an arbitrary wavelength band.

According to a further aspect of the invention, an optical communication system, wherein a cross connecting device in the optical communication system employing a wavelength multiplex transmission method of transmitting an optical signal with wavelengths multiplexed is applied to a node device,

the cross connecting device comprises a first optical demultiplexer for demultiplexing the wavelength multiplexed signal to a wavelength band composed of a plurality of wavelengths, a first matrix switch for receiving input of the wavelength band demultiplexed by the first optical demultiplexer to conduct path switching, a first optical multiplexer for multiplexing outputs of the first matrix switch and outputting the multiplexed signal, a second optical demultiplexer for receiving the wavelength band of an arbitrary band zone branched from at least one of branch ports of the first matrix switch and demultiplexing the band to a signal of each wavelength, a second matrix switch for receiving input of the signal of each wavelength demultiplexed by the second optical demultiplexer to conduct path switching, and a second optical multiplexer for multiplexing outputs of the second matrix switch and sending out the multiplexed signal to at least one of insertion ports of the first matrix switch.

In a cross connecting device according to a first invention, a wavelength multiplexed signal applied through at least one inter-node transmission path is input to at least one first demultiplexer and demultiplexed into a plurality of wavelength bands each including a plurality of wavelengths. The plurality of wavelength bands obtained by demultiplexing by the optical demultiplexer are applied to a matrix switch for changing a path of a wavelength band to have their paths changed and then output. The output wavelength bands are applied to a first optical multiplexer, again multiplexed to a wavelength multiplexed signal which will be output to an inter-node transmission path.

On the other hand, path change on a wavelength basis and add/drop (insertion/branch) at a node in question to a-client are conducted in the following manner. Provided at an input port side of a first matrix switch for changing a path of a wavelength band are a plurality of add ports and provided at an output port side are a plurality of drop ports. To the drop port, a link to a second matrix switch side which conducts path change on a wavelength basis is connected, so that a part of wavelength bands passing through the first matrix switch which conducts path change of wavelength bands passes through the link and is demultiplexed by a second optical demultiplexer on a wavelength basis. The second optical demultiplexer is composed of variable-wavelength filters for demultiplexing a wavelength band of an arbitrary wavelength band zone.

The optical signals demultiplexed on a wavelength basis are applied to the second matrix switch to have their paths changed. The signals having their paths changed are again multiplexed to wavelength bands by a second optical multiplexer, which pass through the link and then connect to the add port of the first matrix switch for conducting path change of a wavelength band. A part of the signals which pass through the second matrix switch is connected to a client interface side and distributed to each client.

As described in the foregoing, since the cross connecting device of the present invention has the second demultiplexer for demultiplexing a wavelength band to a signal on a wavelength basis structured to cope with an arbitrary wavelength band, even when wavelength band zones of wavelength bands to be demultiplexed concentrate on the same wavelength band zone, all the wavelength bands can be demultiplexed.

In addition, while in a case where the second optical demultiplexer is designed to demultiplex a wavelength band of a fixed wavelength band zone, it is necessary to dispose a plurality of the optical demultiplexers of the same kind in advance in order to demultiplex a plurality of wavelength bands of the same wavelength band zone, the cross connecting device of the present invention has none of such necessity. As a result, it is possible to reduce the number of links between the first matrix switch and the second matrix switch, as well as reducing the number of ports of the matrix switch. Furthermore, reduction in kinds of the second optical demultiplexer and reduction in inventory costs are also possible.

In a cross connecting device according to a second invention, with the first optical demultiplexer designed such that a generated wavelength band satisfies that an interval of a wavelength band constituent wavelengths≧a wavelength interval between adjacent wavelength bands×the number of wavelength bands and with the second optical demultiplexer composed of wavelength band pass filters having a transmission band width which is equivalent to the. constituent wavelength interval, an arbitrary wavelength band can be demultiplexed by a serial connection of inexpensive wavelength band pass filters to obtain the effect equivalent to that attained by the first invention.

In a cross connecting device according to a third invention, with the first optical demultiplexer designed to have generated wavelength bands having equal intervals therebetween and with the second optical demultiplexer being arrayed-waveguide gratings (hereinafter referred to as AWG) whose transmission band central wavelength interval coincides with an interval of a generated wavelength band constituent wavelength and whose free spectral range (hereinafter referred to as FSR) coincides with an interval between the wavelength bands, one kind of AWG enables demultiplexing of all the wavelength bands to obtain the effect equivalent to that attained by the first invention.

In a cross connecting device according to a fourth invention, by providing an optical-electrical transducer at a stage succeeding to the second optical demultiplexer and an electrical-optical transducer at a stage succeeding to the second matrix switch and forming the second matrix switch with an electric switch in the first or second or third invention, wavelength change and 3R operation are enabled.

In a cross connecting device according to a fifth invention, with a third optical demultiplexer for demultiplexing a wavelength multiplexed signal from the inter-node transmission path into a node-through signal and a signal to be processed on a wavelength band basis and a wavelength basis, a third matrix switch for conducting path control with a node-through signal as input and a third optical multiplexer for multiplexing an output of the third matrix switch and an output of the second matrix switch provided to set a node-through layer above a layer of the wavelength bands in the first or second or third invention, the number of ports of the first matrix switch can be reduced.

Other objects, features and advantages of the present invention will become clear from the detailed description given herebelow.

### BRIEF DESCRIPTION OF THE DRAWINGS

The present invention will be understood more fully from the detailed description given herebelow and from the accompanying drawings of the preferred embodiment of the invention, which, however, should not be taken to be limitative to the invention, but are for explanation and understanding only.

In the drawings:

FIG. 1 is a block diagram of a cross connecting device showing an example of an embodiment of the present invention;

FIG. 2 is a block diagram showing a structure of a matrix switch according to a first embodiment of the present invention;

FIG. 3 is a block diagram showing a structure of a first optical demultiplexer according to the first embodiment of the present invention;

FIG. 4 is a block diagram showing a structure of a second optical demultiplexer according to the first and second embodiments of the present invention;

FIG. 5 is a diagram showing operation of the second optical demultiplexer according to the first embodiment of the present invention;

FIG. 6 is a block diagram showing a structure of a first optical demultiplexer according to the second embodiment of the present invention;

FIG. 7 is a diagram showing operation of the first optical demultiplexer according to the second embodiment of the present invention;

FIG. 8 is a diagram for use in explaining arrangement of a wavelength band and operation of the second optical demultiplexer according to the second embodiment of the present invention;

FIG. 9 is a diagram for use in explaining arrangement of a wavelength band and operation of a second optical demultiplexer according to a third embodiment of the present invention;

FIG. 10 is a block diagram of a cross connecting device according to a fourth embodiment of the present invention;

FIG. 11 is a block diagram of a cross connecting device according to a fifth embodiment of the present invention;

FIG. 12 is a block diagram showing one example of a conventional cross connecting device; and

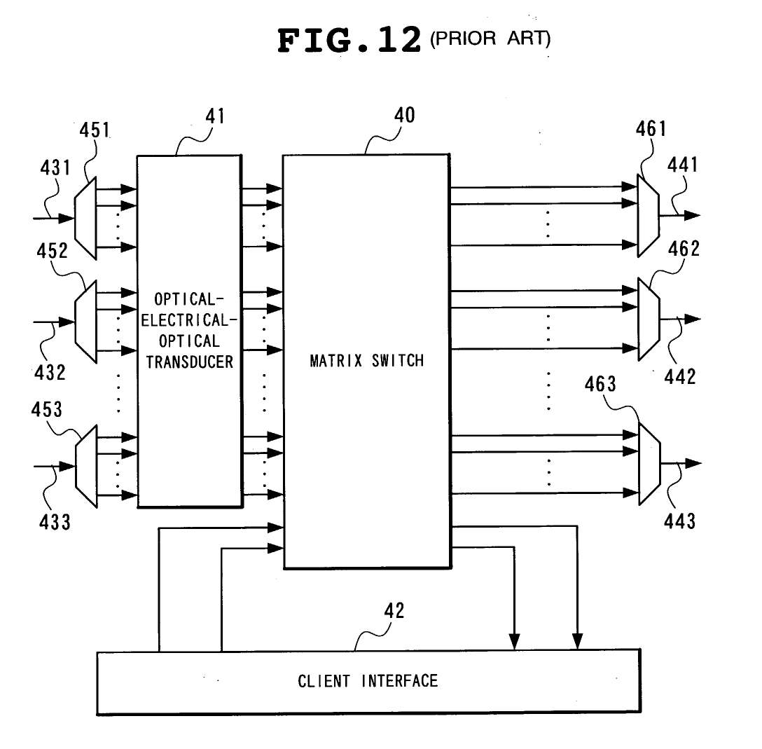

FIG. 13 is a block diagram showing another example of a conventional cross connecting device.

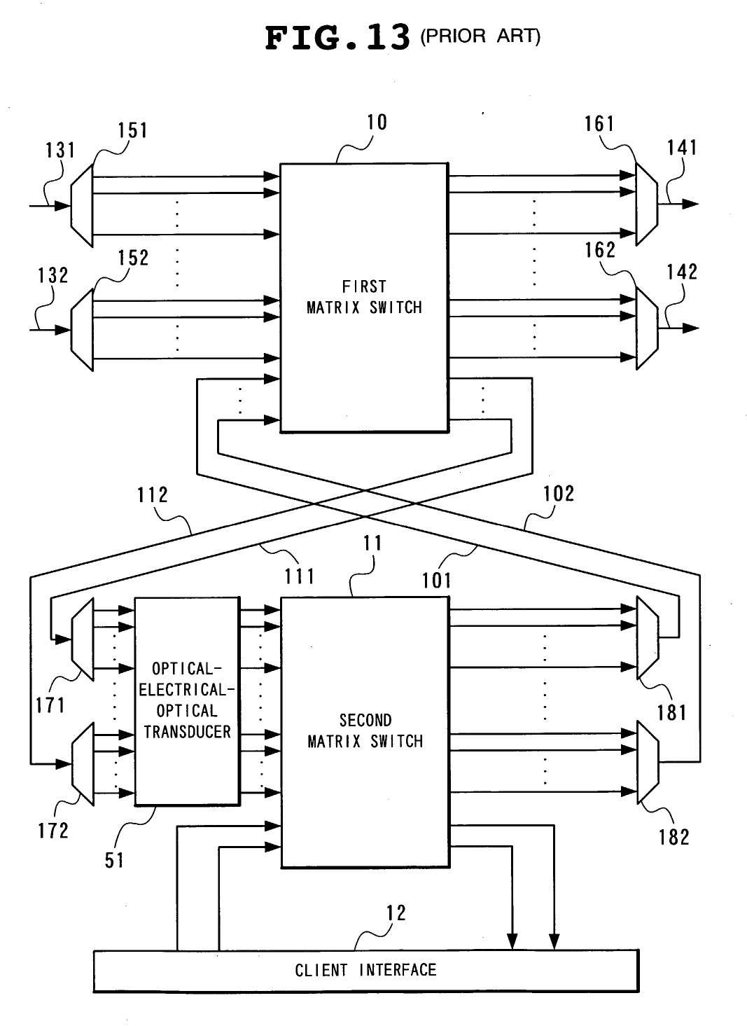

### DESCRIPTION OF THE PREFERRED EMBODIMENT

The preferred embodiment of the present invention will be discussed hereinafter in detail with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to unnecessary obscure the present invention.

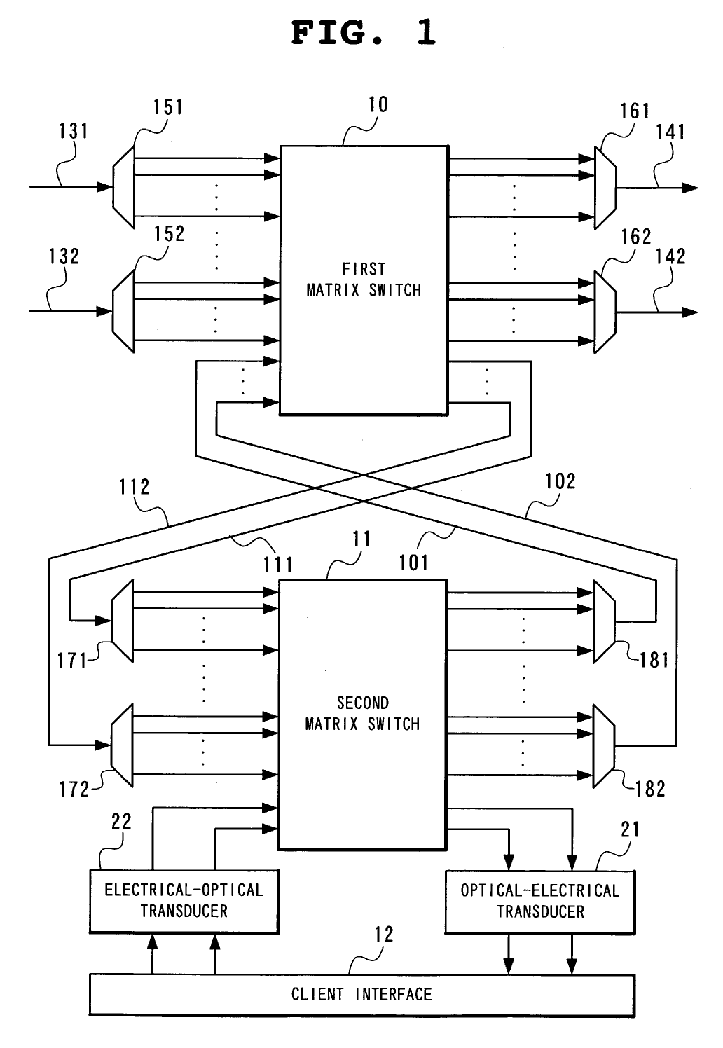

FIG. 1 is a schematic diagram of a cross connecting device according to a first embodiment of the present invention. In the figure, the present cross connecting device includes a first matrix switch 10, a second matrix switch 11, first optical demultiplexers 151 and 152, first optical multiplexers 161 and 162, second optical demultiplexers 171 and 172, second optical multiplexers 181 and 182, links 101, 102, 111 and 112 connecting the first matrix switch 10 and the second matrix switch 11, and a client interface 12.

A plurality of inter-node transmission paths 131 and 132 are connected to input ports of the plurality of the first optical demultiplexers 151 and 152 and output ports of the plurality of the first demultiplexers are connected to input ports of the first matrix switch. Output ports of the first matrix switch 10 are connected to input ports of the plurality of the first optical multiplexers 161 and 162 and output ports of the plurality of the first optical multiplexers 161 and 162 are connected to a plurality of inter-node transmission paths 141 and 142.

On the other hand, provided on the input port side of the first matrix switch 10 are a plurality of add ports and provided on the output port side are a plurality of drop ports. To the drop ports, the links 111 and 112 are connected to connect to input ports of the plurality of the second optical demultiplexers 171 and 172. To the add ports, the links 101 and 102 are connected to connect to output ports of the plurality of the second optical multiplexers 181 and 182. Outputs of the plurality of the second optical demultiplexers 171 and 172 are connected to input ports of the second matrix switch 11 and the plurality of the second optical multiplexers 181 and 182 are connected to output ports of the second matrix switch 11.

Also, prepared on the output port side of the second matrix switch 11 are a plurality of drop ports to clients and prepared on the input port side are a plurality of add ports from clients, which are connected to the client interface 12 through an optical-electrical transducer 21 and an electrical-optical transducer 22.

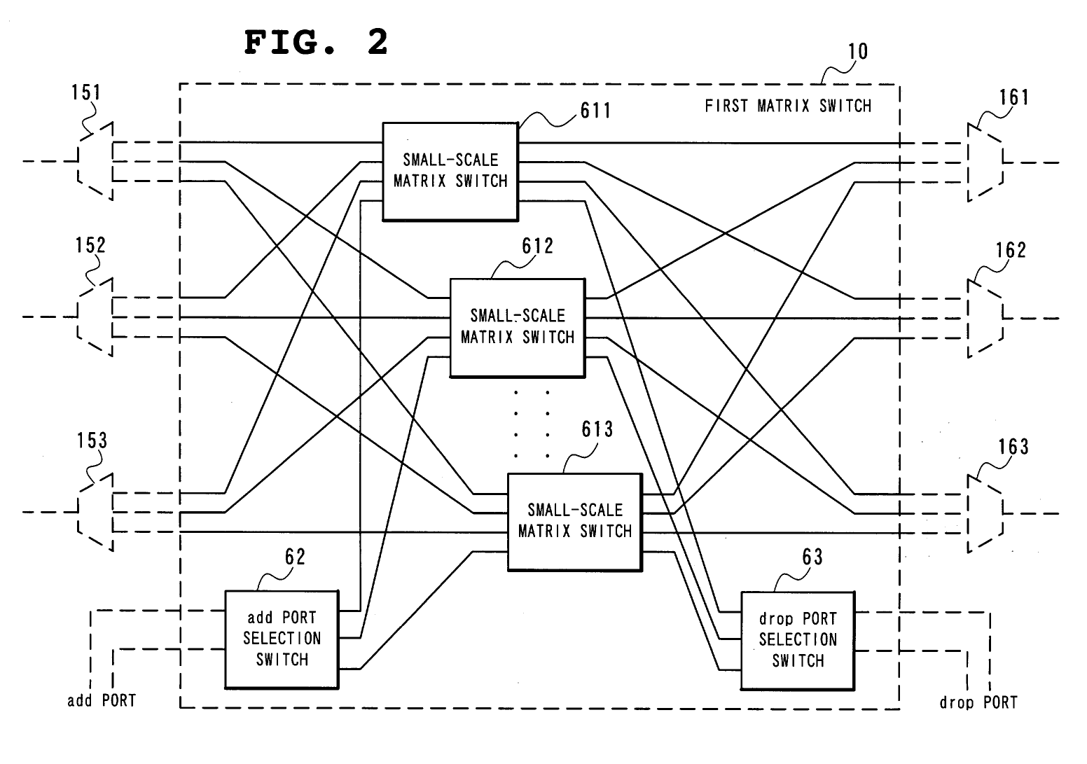

Next, each component will be described. First, a structure of the first matrix switch will be described with reference to FIG. 2. The first matrix switch 10, which is an optical space matrix switch for conducting path change of an optical signal, includes a plurality of small-scale matrix switches 611, 612 and 613, and an add port selection switch 62 and a drop port selection switch 63. The small-scale matrix switches 611, 612 and 613 and the selection switches 62 and 63 are also optical space matrix switches. Input ports of the optical small-scale matrix switches 611, 612 and 613 are connected to the first optical demultiplexers 151, 152 and 153 in such a manner that out of optical signals demultiplexed by the first optical demultiplexers 151, 152 and 153, wavelength bands of the same wavelength band zone are applied to the same one of the small-scale matrix switches 611, 612 and 613.

For example, to the small-scale matrix switch 611, a wavelength band whose constituent wavelengths are λ1 to λ4 is applied, while to the small-scale matrix switch 612, a wavelength band whose constituent wavelengths are λ5 to λ8 is applied. In addition, output ports of the small-scale optical matrix switches 611, 612 and 613 are connected to the first optical multiplexers 161, 162 and 163 in such a manner that the output port of one small-scale matrix switch 611, for example, is connected to all the first optical multiplexers 161, 162 and 163.

On the other hand, to the input ports of the small-scale matrix switches 611, 612 and 613, at least one link is connected to the add port selection switch 62 and to the output ports of the small-scale matrix switches 611, 612 and 613, at least one link is connected to connect to the drop port selection switch 63.

Although in the present embodiment, the first matrix switch 10 is composed of the plurality of the small-scale optical matrix switches and the add/drop port selection switches, it may be formed of one large-scale optical switch.

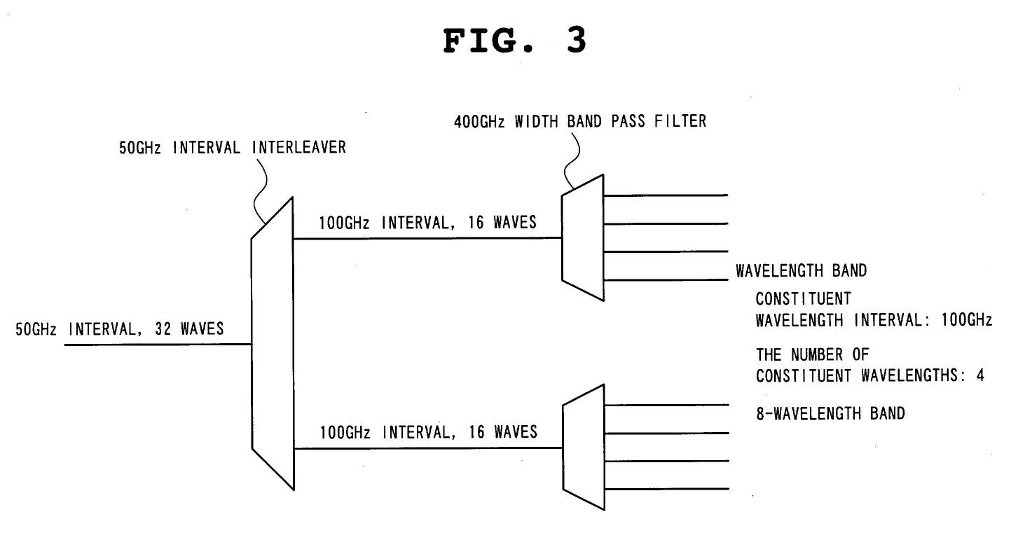

The first optical demultiplexers 151 and 152 are made up of variable-wavelength selecting filters or fixed-wavelength filters such as an AWG and a thin film filter, an example of which structure is shown in FIG. 3. Although shown in FIG. 3 is a combination of fixed-wavelength filters, the optical demultiplexers may be made up of variable-wavelength selecting filters. The optical demultiplexer being composed of variable-wavelength filers enables arbitrary selection of the number of constituent wavelengths and a constituent wavelength of a wavelength band. The first optical multiplexers 161 and 162 are composed of fixed-wavelength filters such as an AWG and a thin film filter, or photo couplers.

The second matrix switch 11, which is an optical space matrix switch, may be composed of a plurality of small-scale optical matrix switches and add/drop port selection switches or one large-scale optical switch similarly to the first matrix switch 10.

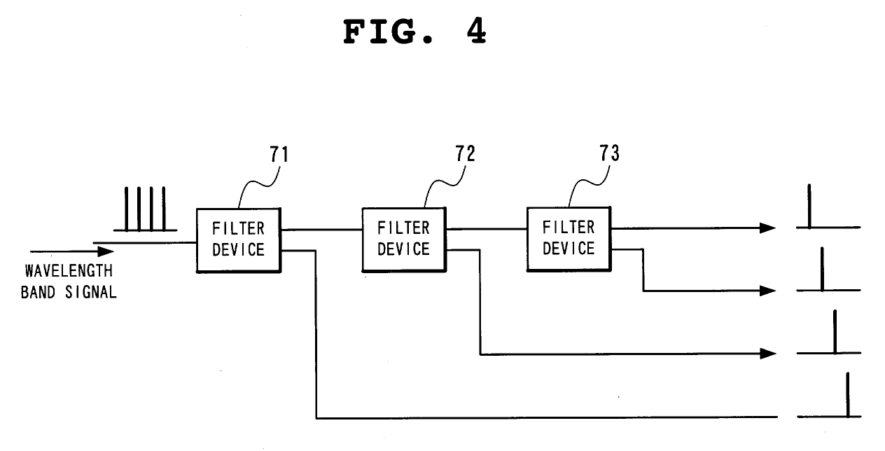

The second optical demultiplexers 171 and 172 have a variable-wavelength filter structure enabling demultiplexing of a wavelength band of an arbitrary wavelength band zone. FIG. 4 shows an example of a structure of the second optical demultiplexers 171 and 172. In the present structure example, the number of constituent wavelengths of one wavelength band is assumed to be four. Each of the second optical demultiplexes 171 and 172 is made up of filter devices 71 to 73 connected in series. In this case, the filter devices 71 to 73 are composed of variable-wavelength filters capable of tuning a signal to have a desired wavelength which is to be obtained by demultiplexing. The wavelength band signal is demultiplexed one wavelength each every time it passes through the filter devices 71 to 73 to ultimately have all the four wavelengths demultiplexed.

In addition, since the variable-wavelength filter is capable of tuning a signal to an arbitrary wavelength, demultiplexing a wavelength band signal of an arbitrary wavelength band zone is possible. Although in the present embodiment, because the number of wavelength band constituent wavelengths is assumed to be four, the filter devices are connected in series in three stages, when the number of constituent wavelengths is increased, increasing the number of filter devices enables demultiplexing of a wavelength band composed of an arbitrary number of wavelengths. Moreover, while the filter device of the present embodiment is assumed to demultiplex one wavelength each, one filter device may demultiplex a plurality of wavelengths. The variable-wavelength filter is formed of, for example, a Fabry-Perot type tunable filter, a tunable filter using fiber gratings, or the like.

The second optical multiplexers 181 and 182 are formed of photo couplers or devices for multiplexing an optical signal of an arbitrary wavelength.

Although the electrical-optical transducer 22 may be formed of a fixed-wavelength laser, since a wavelength band zone of a wavelength band demultiplexed by the second demultiplexers 171 and 172 and dropped to the client can be arbitrarily selected, numbers of the electrical-optical transducers 22 are necessary for the adding corresponding to the wavelength band zones of the dropped wavelength bands. On the other hand, with the electrical-optical transducer 22 being formed of a variable-wavelength laser, because a signal added from the client can be accordingly formed into a wavelength band of an arbitrary band zone, the number of the electrical-optical transducers 22 can be reduced.

Moreover, while in the present embodiment, a layer of a wavelength band for conducting path change on a wavelength band basis and a layer of a wavelength for conducting path change on a wavelength basis are provided, a fiber switch layer in which a fiber switch for conducting path change on a fiber basis is disposed may be provided on the layer of a wavelength band.

Operation of the present embodiment will be described in the following. First, with reference to FIG. 1, a signal flow will be described. Signals transmitted through the inter-node transmission paths 131 and 132 are applied to the first optical demultiplexers 151 and 152. The signals transmitted through the inter-node transmission paths 131 and 132 are wavelength multiplexed signals and therefore will be demultiplexed by the first optical demultiplexers 151 and 152 on a wavelength band basis. Method of demultiplexing to wavelength bands will be described with reference to FIG. 3. In the present example of structure, a wavelength multiplexed signal transmitted through the inter-node transmission path is assumed, as an example, to have an interval of 50 GHz and the number of constituent wavelengths of 32.

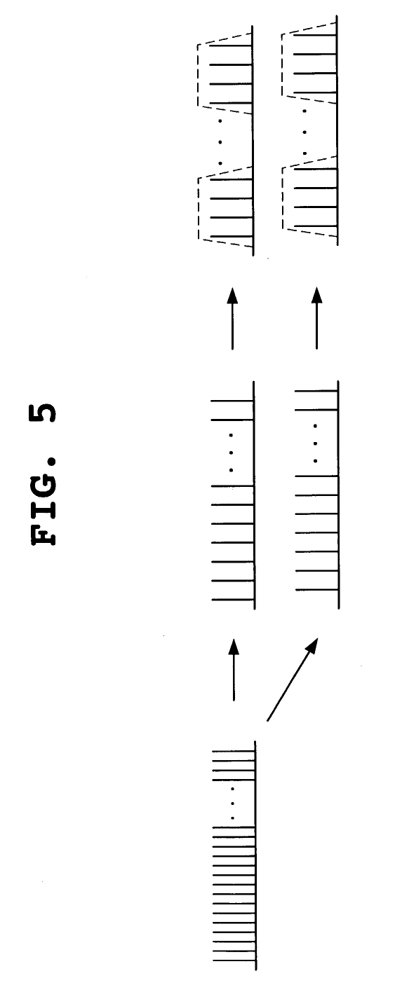

First, by a 50 GHz interleaver at a first stage, the signal is demultiplexed into two signals whose interval is 100 GHz and whose number of constituent wavelengths is 16. Interleaver is a filter for demultiplexing a series of optical signals into odd-numbered signals and even-numbered signals. Furthermore, by a 400 GHz band pass filter at a second stage, the signals are demultiplexed into eight wavelength bands whose interval is 100 GHz and whose number of constituent wavelengths is four. The foregoing wavelength demultiplexing process is shown in FIG. 5. Although in the present embodiment, the wavelength bands are assumed to have a uniform constituent wavelength interval (100 GHz in the present embodiment) and the same number of constituent wavelengths (four in the present embodiment), the constituent wavelength interval of a generated wavelength band may not be uniform and the number of constituent wavelengths may vary.

The signals thus demultiplexed into wavelength bands are applied to the first matrix switch 10. Next, with reference to FIG. 2, a signal flow in the first matrix switch 10 will be described. The wavelength bands obtained by demultiplexing at the first optical demultiplexers 151 and 152 are applied to the small-scale matrix switches 611, 612 and 613 on a wavelength band zone basis. The signals passing as the wavelength bands through the cross connecting device have their paths changed so as to be connected to desired inter-node transmission paths by the small-scale matrix switches 611, 612 and 613 and then output from the first matrix switch 10. The output wavelength bands are applied to the first optical multiplexing units 161 and 162, again wavelength-multiplexed and then output to the inter-node transmission paths 141 and 142.

On the other hand, signals to be subjected to such processing on a wavelength basis as switching between wavelength band constituent wavelengths and distribution to a client at a node in question have their paths changed at the small-scale matrix switches 611, 612 and 613 such that they are applied to the drop port selection switch 63, which signals are then applied to the second optical demultiplexers 171 and 172 through the links 111 and 112. The wavelength bands applied to the second optical demultiplexers 171 and 172 are demultiplexed on a wavelength basis and then applied to the second switch matrix 11. Since the second optical demultiplexers 171 and 172 for demultiplexing a wavelength band are capable of demultiplexing a wavelength band of an arbitrary wavelength band zone, a wavelength band of an arbitrary wavelength band zone can be dropped from the first matrix switch 10 to the second matrix switch 11.

Next, processing on a wavelength basis will be described. Signals demultiplexed to one wave each and applied to the second switch matrix 11 have their paths switched so as to be connected to the second wavelength multiplexer for conducting multiplexing to a desired wavelength band. Thus, constituent wavelengths of wavelength bands demultiplexed by the second optical demultiplexers 171 and 172, for example, can be switched. The signals having their paths changed are applied to the second optical multiplexers 181 and 182 and again multiplexed to wavelength bands. The generated wavelength bands are applied to the first matrix switch 10 through the links 101 and 102.

Here, with reference to FIG. 2, description will be made of a flow of a signal added from the second matrix switch 11 to the first matrix switch 10. The wavelength bands applied from the second matrix switch 11 to the first matrix switch 10 through the links 101 and 102 are applied to the add port selection switch 62 to have their paths changed so as to be connected to the small-scale matrix switches 611, 612 and 613 corresponding to wavelength band zones of the wavelength bands.

For example, in a case where the small-scale matrix switch 611 conducts path change of a wavelength band of a wavelength band zone ranging from λ1 to λ4, when the wavelength band added from the second matrix switch 11 ranges from λ1 to λ4, the add port selection switch 62 is connected to the small-scale matrix switch 611. The signals added from the second matrix switch 11 have their paths switched at the small-scale matrix switches 611, 612 and 613 so as to be connected to a desired inter-node transmission path and output from the first matrix switch 10. The output wavelength bands are applied to the first optical multiplexing units 161 and 162 and again wavelength-multiplexed, and then output to the inter-node transmission paths 141 and 142.

On the other hand, after being converted to an electric signal by the optical-electrical transducer 21, the drop signal from the second matrix switch 11 to the client is applied to the client interface 12 and then transmitted to each client. The add signal from the client to the transmission path is applied to the client interface 12 and converted into an optical signal by the electrical-optical transducer 22 and then applied to the second matrix switch 11. The signal applied to the second matrix switch has its path changed by the second matrix switch 11 so as to be formed of a desired wavelength band. The signals having their paths changed, after being multiplexed by the second optical multiplexers 181 and 182, are added to the first matrix switch 10 and sent out to the inter-node transmission paths 141 and 142.

When there is no client as in an intermediate node, the device is structured not to include the client interface 12, the optical-electrical transducer 21 and the electrical-optical transducer 22.

As described in the foregoing, since the cross connecting device according to the present invention has a structure which enables the second optical demultiplexers 171 and 172 for demultiplexing a wavelength band into signals on a wavelength basis to cope with an arbitrary wavelength band, even when wavelength band zones of wavelength bands to be demultiplexed concentrate on the same wavelength band zone, all the wavelength bands can be demultiplexed.

In a case where the second optical demultiplexers 171 and 172 have a structure for demultiplexing a wavelength band of a fixed wavelength band zone, although demultiplexing a plurality of wavelength bands of the same wavelength band zone requires provision of a plurality of optical demultiplexers of the same kind in advance, the cross connecting device of the present invention needs none of such provision. As a result, it is possible to reduce the number of the links 101, 102, 111 and 112 between the first matrix switch 10 and the second matrix switch 11, as well as reducing the number of ports of the matrix switches. Kinds of the second optical demultiplexers 171 and 172 can be also drastically reduced to cut down inventory costs.

Next, a second embodiment of the present invention will be described in detail with reference to the drawings. As to its structure, description will be made only of a part different from the structure example of the first embodiment. FIG. 1 is a structural diagram showing the second embodiment of the present invention. Differences from the structure of the first embodiment here are a method of forming a wavelength band and a method of demultiplexing a wavelength band to signals on a wavelength basis, and the structure of the first optical demultiplexers 151 and 152 for forming a wavelength band and the structure of the second demultiplexers 171 and 172 for demultiplexing a wavelength band to a signal on a wavelength basis.

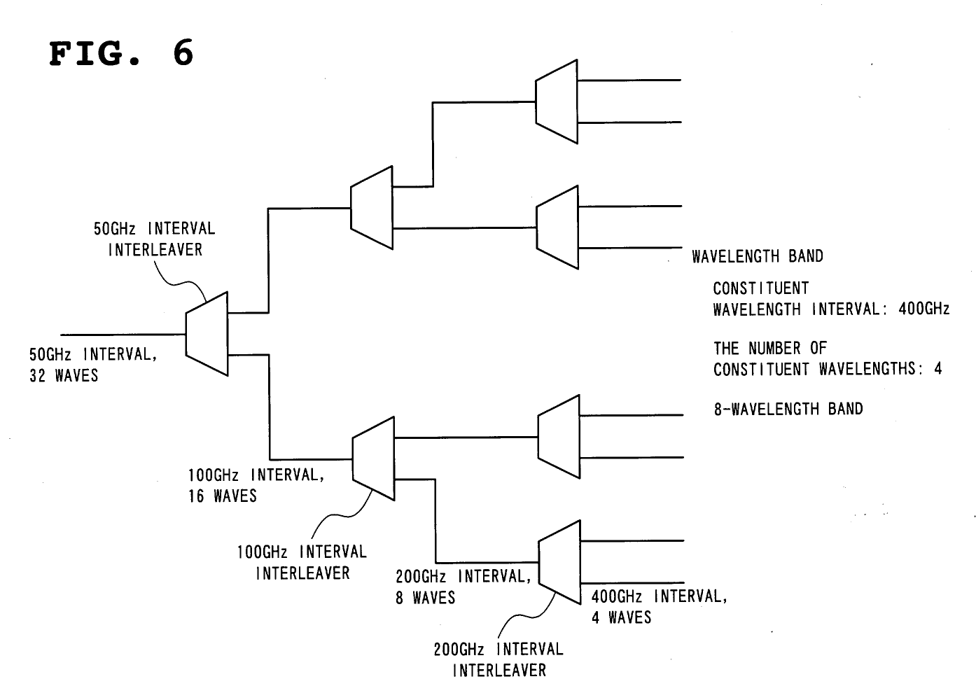

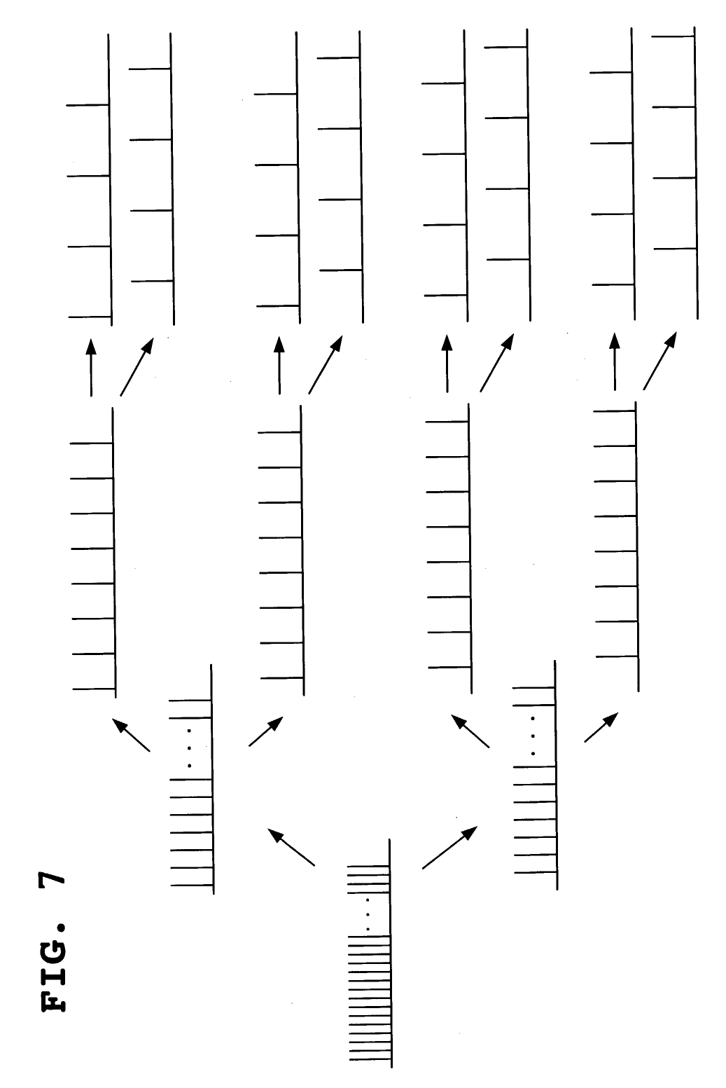

Example of the structure of the first optical demultiplexers 151 and 152 is shown in FIG. 6. Although shown in FIG. 6 is a combination of fixed-wavelength filters, the demultiplexer may be formed of variable-wavelength filters. Method of demultiplexing to a wavelength band will be described with reference to FIG. 6. In the present structure example, a wavelength-multiplexed signal transmitted through the inter-node transmission path is assumed to have an interval of 50 GHz and the number of constituent wavelengths of 32 as an example. First, by the 50 GHz interleaver at the first stage, the signal is demultiplexed to two signals whose interval is 100 GHz and whose number of constituent wavelengths is 16. Furthermore, by the 100 GHz interleaver at the second stage, the signals are demultiplexed to four signals whose intervals is 200 GHz and whose number of constituent wavelengths is eight. Moreover, by a 200 GHz interleaver at the third stage, the signals are demultiplexed to eight signals whose interval is 400 GHz and whose number of constituent wavelengths is four. The foregoing process of demultiplexing wavelengths is shown in FIG. 7.

Wavelength bands are thus formed to satisfy that a wavelength band constituent wavelength interval≧a wavelength interval between adjacent wavelength bands×the number of wavelength bands. The second optical demultiplexers 171 and 172 for demultiplexing a generated wavelength band are formed, similarly to the structure of the first embodiment shown in FIG. 4, of a serial connection of filter devices. At this time, the filter device is formed of wavelength band pass filters having a transmission band width equivalent to the constituent wavelength interval.

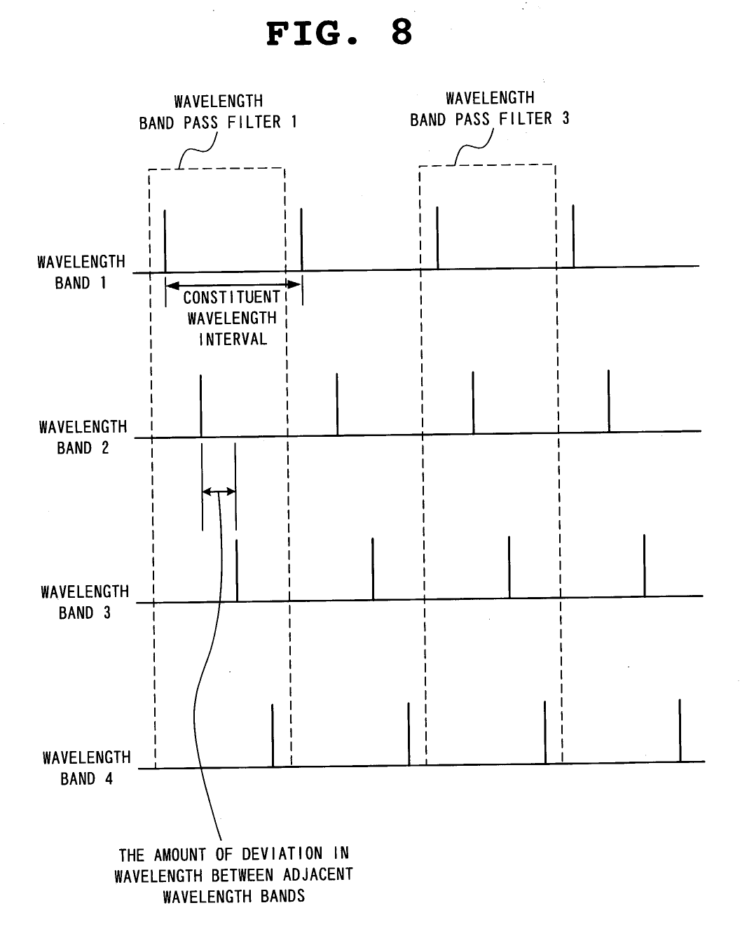

Next, wavelength band demultiplexing operation will be described with reference to FIG. 8. In the operation of demultiplexing a wavelength band 1, for example, a first constituent wavelength of the wavelength band is demultiplexed by a first wavelength band pass filter. Similarly, a third constituent wavelength is demultiplexed by a third wavelength band pass filter. In the operation of demultiplexing a wavelength band 2, since the first constituent wavelength is within a transmission band of the first wavelength band pass filter, it is similarly demultiplexed by the first wavelength band pass filter. The third constituent wavelength is similarly demultiplexed by the third wavelength band pass filter.

In other words, thus formed wavelength bands allow a serial connection of inexpensive wavelength band pass filters to demultiplex an arbitrary wavelength band and further enable an inexpensive cross connecting device to obtain the effect equivalent to that achieved by the first embodiment.

Next, a third embodiment of the present invention will be described in detail with reference to the drawings. As to its structure, description will be made only of a part different from the structure example of the first embodiment. FIG. 1 is a structural diagram showing the third embodiment of the present invention. Differences from the structure of the first embodiment here are a method of forming a wavelength band and a method of demultiplexing a wavelength band to signals on a wavelength basis, and the structure of the first optical demultiplexers 151 and 152 for forming a wavelength band and the structure of the second demultiplexers 171 and 172 for demultiplexing a wavelength band to signals on a wavelength basis. More specifically, the first optical demultiplexer is structured to have its generated wavelength bands having equal intervals therebetween. In addition, the second optical demultiplexers 171 and 172 are formed of AWGs whose transmission band central wavelength interval is coincident with a generated wavelength band constituent wavelength interval and whose FSR is coincident with an interval between adjacent wavelength bands.

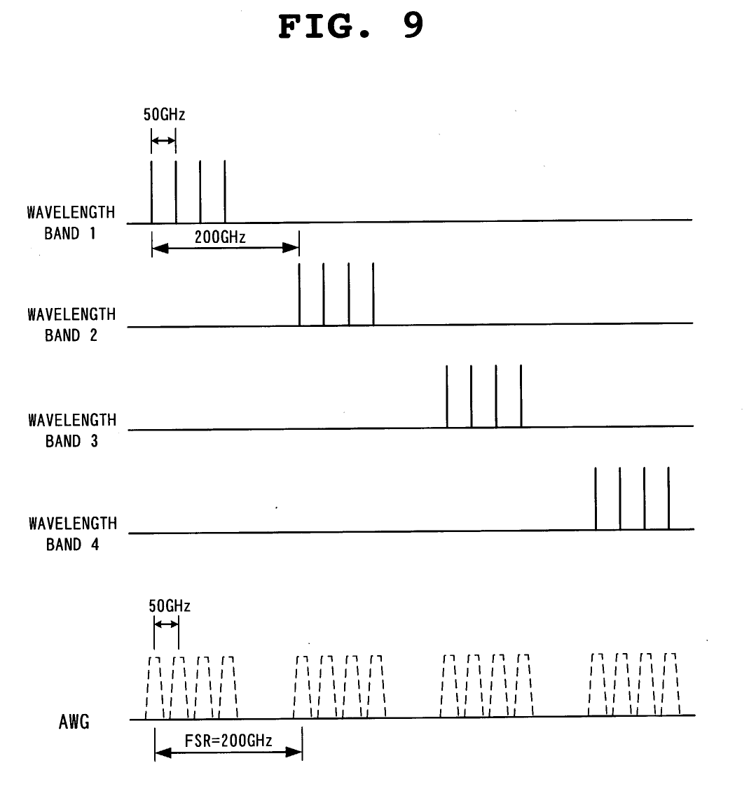

One example of a wavelength band and that of an AWG structured as shown in FIG. 9 will be described. In the present embodiment, the wavelength band is structured to have a constituent wavelength interval of 50 GHz and the number of constituent wavelengths of four and the AWG is set to have a central wavelength interval of its transmission band be 50 GHz and its FSR be 200 GHz. One of characteristics of an AWG is a cyclic transmission wavelength. More specifically, as shown in FIG. 9, since in the AWG, the 0-th, first, . . . -th diffraction occur in a cycle set by FSR, cyclically aligned wavelength bands can be demultiplexed. In other words, by thus forming the wavelength band and the AWG which demultiplexes the bands, an arbitrary wavelength band can be demultiplexed by one kind of AWG and furthermore, an inexpensive cross connecting device is allowed to obtain the effect equivalent to that achieved by the first embodiment.

In addition, although in the present embodiment, an AWG is used as the second optical demultiplexer, such a filter making use of a light diffraction phenomenon as a Fabry-Perot type filter, a thin film filter and a filter using fiber gratings can be widely used.

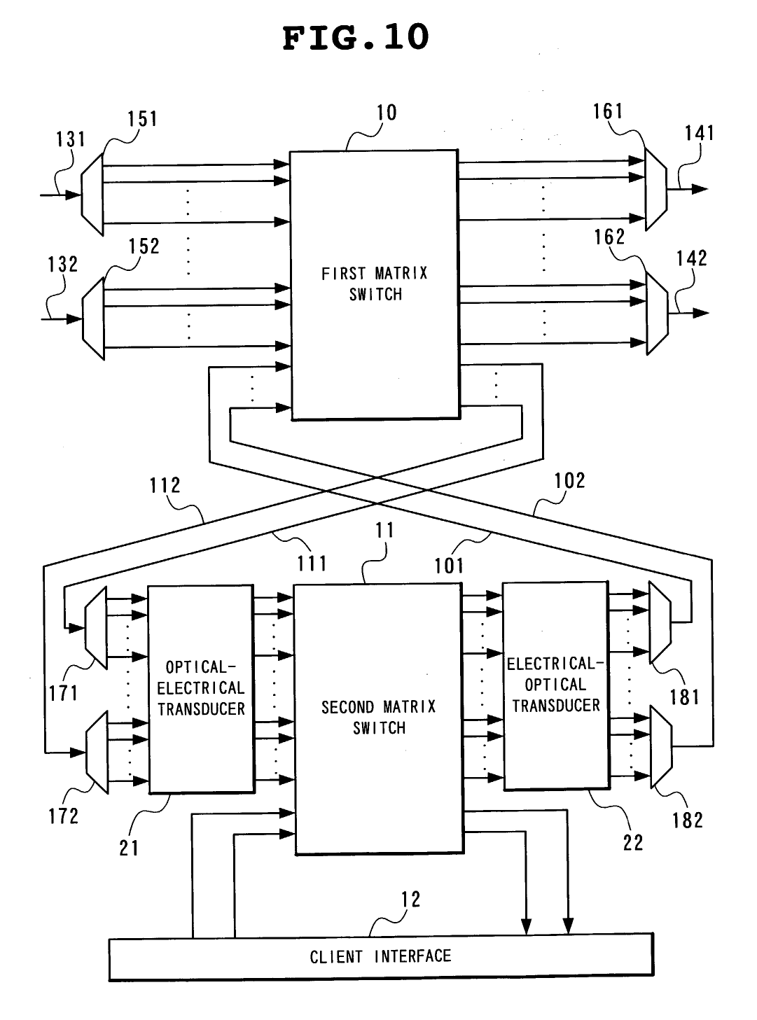

Next, a fourth embodiment of the present invention will be described in detail with reference to the drawings. As to its structure, description will be made only of a part different from the structure example of the first embodiment. FIG. 10 is a structural diagram showing the fourth embodiment. The second matrix switch 11 is formed of an electric switch. In addition, the optical-electrical transducer 21 for converting an optical signal to an electric signal is disposed at a stage succeeding to the second optical demultiplexers 171 and 172. Similarly, the electrical-optical transducer 22 is disposed at a stage succeeding to the second matrix switch 11. Although the electrical-optical transducer 22 may be formed of a fixed-wavelength laser, since a wavelength band zone of the wavelength band to be demultiplexed by the second demultiplexers 171 and 172 can be arbitrarily selected, numbers of the electrical-optical transducers 22 are required for the multiplexing corresponding to wavelength band zones of the demultiplexed wavelength bands.

On the other hand, the electrical-optical transducer 22 being formed of a variable-wavelength laser will be capable of coping with a wavelength band of an arbitrary wavelength band zone, so that it is possible to reduce the number of the electrical-optical transducers 22. The signals obtained by demultiplexing on a wavelength basis by the second optical demultiplexers 171 and 172 are converted into electric signals by the optical-electrical transducer 21 and then have their paths changed by the second matrix switch 11 so as to have a desired wavelength band. The electric signals having their paths changed are again converted into optical signals by the electrical-optical transducer 22 so as to have a wavelength band of a desired wavelength band zone. The foregoing arrangement enables the cross connecting device to conduct wavelength conversion and 3R (Re-Shaping: equivalent amplification, Re-Timing: timing reproduction, Re-Generating: identification reproduction) operation.

In the present embodiment, although a layer of a wavelength band for conducting path change on a wavelength band basis and a layer of a wavelength for conducting path change on a wavelength basis are provided, a fiber switch layer in which a fiber switch for conducting path change on a fiber basis is disposed may be provided on the layer of a wavelength band. The first optical demultiplexers 151 and 152 and the second optical demultiplexers 171 and 172 may have any structure of the above-described first to third embodiments.

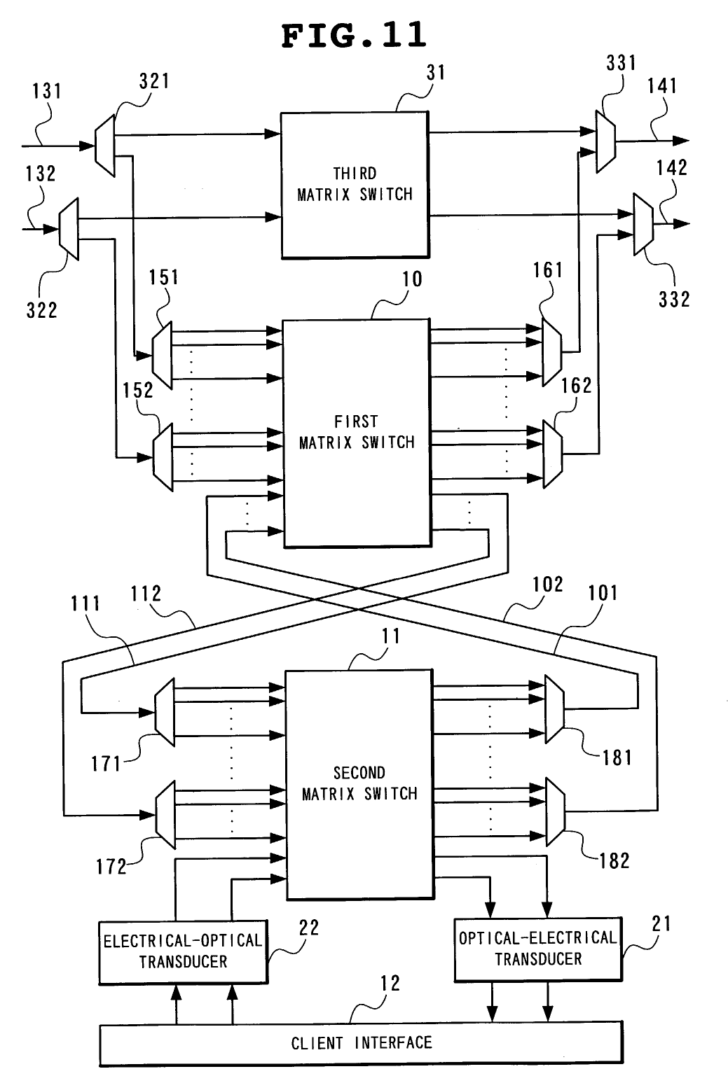

Next, a fifth embodiment of the present invention will be described in detail with reference to the drawings. As to its structure, description will be made only of a part different from the structure example of the first embodiment. FIG. 11 is a structural diagram showing the fifth embodiment. The plurality of the inter-node transmission paths 131 and 132 are connected to input ports of a plurality of third optical demultiplexers 321 and 322 and output ports of the plurality of the third demultiplexers 321 and 322 are connected to input ports of a third matrix switch 31 and to the first optical demultiplexers 151 and 152.

In addition, output ports of the third matrix switch 31 and the output ports of the first optical multiplexers 161 and 162 are connected to input ports of a plurality of third optical multiplexers 331 and 332. Furthermore, output ports of the third optical multiplexers 331 and 332 are connected to the plurality of the inter-node transmission paths 141 and 142. Here, the third matrix switch 31 is formed of an optical space switch.

Next, operation of the fifth embodiment will be described. Signals transmitted through the inter-node transmission paths 131 and 132 are applied to the third optical demultiplexers 321 and 322. The signals transmitted through the inter-node transmission paths 131 and 132 are wavelength-multiplexed signals, and are demultiplexed to signals whose paths will be changed on a wavelength band basis and a wavelength basis and signals whose paths will not be changed on a wavelength band basis and a wavelength basis by the third optical demultiplexers 321 and 322. The signals whose paths will be changed on a wavelength band basis and a wavelength basis are applied to the first optical demultiplexers 151 and 152 and thereafter subjected to operation processing similar to that of the first embodiment.

On the other hand, the signals whose paths will not be changed on a wavelength band basis and a wavelength basis, that is, the signals which will pass through the nodes, are applied to the third matrix switch 31 to have their paths changed. The signals whose paths have been changed are multiplexed by the third optical multiplexers 331 and 332 with the signals whose paths have been changed on a wavelength band basis and a wavelength basis and sent out to the inter-node transmission paths 141 and 142.

In the first embodiment described above, the node-through signals whose paths will not be changed on a wavelength band basis and a wavelength basis are also once demultiplexed on a wavelength band basis and then applied to the first matrix switch 10. By thus providing, on the layer of a wavelength band, a node-through layer in which the third matrix switch 31 for controlling paths of a node-through signal is arranged, the number of ports of the first matrix switch 10 can be reduced. In addition, the ports of the third matrix switch 31 are only required as many as the number of the inter-node transmission paths, so that the switch can be formed of an extremely small-scale optical matrix switch. Here, the effect of reducing the number of ports as compared with the structure example of the first embodiment will be described.

In a case, for example, where the number of inter-node transmission paths is 15, the number of wavelengths multiplexed is 160 and the number of constituent wavelengths of a wavelength band is four, the structure example of the first embodiment should prepare 600 (=15×(160/4)) ports for the first matrix switch 10. On the other hand, when the node-through signals occupy 50%, the structure example of the present embodiment should prepare only 300 (=15×(160/4)/2)) ports for the first matrix switch 10. The number of ports of the third matrix switch 31 newly added is 15. Thus, provision of a node-through layer enables the matrix switch constituting the cross connecting device to be reduced in scale to realize down-sizing and cost-down of the device.

Moreover, on the node-through layer, a fiber switch layer in which a fiber switch for conducting path change-on a fiber basis is disposed may be provided. The first optical demultiplexers 151 and 152 and the second optical demultiplexers 171 and 172 may have any structure of the first to third embodiments.

According to the present invention, by structuring the cross connecting device which conducts path change on a wavelength band basis and a wavelength basis such that the second optical demultiplexer on the link connecting the first matrix switch and the second matrix switch can demultiplex an arbitrary wavelength band, as compared with a conventional system in which the device includes an optical demultiplexer for demultiplexing a wavelength band of a fixed wavelength band zone, further reduction in kinds of optical demultiplexers to be prepared can be realized to cut down inventory costs.

Further effect is enabling demultiplexing of all wavelength bands even when in one cross connecting device, wavelength band zones of wavelength bands to be demultiplexed concentrate on the same wavelength band zone.

Moreover, it is possible to reduce the number of links between the first matrix switch and the second matrix switch, as well as reducing the scale of the first and the second matrix switches, thereby enabling the cross connecting device to be reduced in size and in costs.

Although the invention has been illustrated and described with respect to exemplary embodiment thereof, it should be understood by those skilled in the art that the foregoing and various other changes, omissions and additions may be made therein and thereto, without departing from the spirit and scope of the present invention. Therefore, the present invention should not be understood as limited to the specific embodiment set out above but to include all possible embodiments which can be embodies within a scope encompassed and equivalents thereof with respect to the feature set out in the appended claims.

In the claims:

1. A cross connecting device, comprising:
a first matrix switch for conducting path change of an applied wavelength multiplexed signal on the basis of a plurality of wavelength bands,
a second matrix switch for switching a path of a part of switch outputs from the first matrix switch on a wavelength basis, and
an optical demultiplexer provided on a link connecting said first and second matrix switches and capable of demultiplexing an arbitrary wavelength band.

2. The cross connecting device as set forth in claim 1, further comprising
a third matrix switch for switching a path of a node-through signal out of said wavelength multiplexed signal.

3. A cross connecting device in an optical communication system employing a wavelength multiplex transmission method of transmitting an optical signal with wavelengths multiplexed, comprising:
a first optical demultiplexer for demultiplexing said wavelength multiplexed signal to a wavelength band composed of a plurality of wavelengths,
a first matrix switch for receiving input of said wavelength band demultiplexed by said first optical demultiplexer to conduct path switching,
a first optical multiplexer for multiplexing outputs of said first matrix switch and outputting the multiplexed signal,
a second optical demultiplexer for receiving said wavelength band of an arbitrary band zone branched from at least one of branch ports of said first matrix switch and demultiplexing the band to a signal of each wavelength,
a second matrix switch for receiving input of said signal of each wavelength demultiplexed by said second optical demultiplexer to conduct path switching, and
a second optical multiplexer for multiplexing outputs of said second matrix switch and sending out the multiplexed signal to at least one of insertion ports of said first matrix switch.

4. The cross connecting device according to claim 3, further comprising:
an optical-electrical transducer provided at a stage succeeding to said second optical demultiplexer, and
an electrical-optical transducer provided at a stage succeeding to said second matrix switch, wherein said second matrix switch is formed of an electric switch.

5. The cross connecting device as set forth in claim 4, further comprising
a client interface for receiving an electric signal branched from at least one of branch ports of said second matrix switch and transmitting the same to a client, as well as receiving an electric signal from said client and transmitting the same to at least one of the insertion ports of said second matrix switch.

6. The cross connecting device as set forth in claim 3, further comprising:
an optical-electrical transducer for receiving said signal of each wavelength which is branched from at least one of branch ports of said second matrix switch to convert the signal to an electric signal,
a client interface for transmitting the electric signal converted by said optical-electrical transducer to a client, as well as receiving an electric signal from said client, and
an electrical-optical transducer for converting the electric signal received by said client interface into an optical signal and transmitting the converted signal to at least one of the insertion ports of said second matrix switch.

7. The cross connecting device as set forth in claim 4, wherein
said electrical-optical transducer is formed of a variable-wavelength laser.

8. The cross connecting device as set forth in claim 3, further comprising:
an optical-electrical transducer for receiving said signal of each wavelength which is branched from at least one of branch ports of said second matrix switch to convert the signal to an electric signal,
a client interface for transmitting the electric signal converted by said optical-electrical transducer to a client, as well as receiving an electric signal from said client, and
an electrical-optical transducer for converting the electric signal received by said client interface into an optical signal and transmitting the converted signal to at least one of the insertion ports of said second matrix switch, wherein
said electrical-optical transducer is formed of a variable-wavelength laser.

9. The cross connecting device as set forth in claim 3, further comprising:
a third optical demultiplexer for demultiplexing said wavelength multiplexed signal to a node-through signal and a signal to be subjected to processing on the basis of said wavelength band and said wavelength,
a third matrix switch for receiving input of said node-through signal to conduct path switching, and
a third optical multiplexer for multiplexing an output of said third matrix switch and an output of said first optical multiplexer.

10. The cross connecting device as set forth in claim 3, further comprising:
an optical-electrical transducer provided at a stage succeeding to said second optical demultiplexer, and
an electrical-optical transducer provided at a stage succeeding to said second matrix switch, wherein said second matrix switch is formed of an electric switch, and further comprising:
a third optical demultiplexer for demultiplexing said wavelength multiplexed signal to a node-through signal and a signal to be subjected to processing on the basis of said wavelength band and said wavelength,
a third matrix switch for receiving input of said node-through signal to conduct path switching, and
a third optical multiplexer for multiplexing an output of said third matrix switch and an output of said first optical multiplexer.

11. The cross connecting device as set forth in claim 4, further comprising:
a client interface for receiving an electric signal branched from at least one of branch ports of said second matrix switch and transmitting the same to a client, as well as receiving an electric signal from said client and transmitting the same to at least one of the insertion ports of said second matrix switch,
a third optical demultiplexer for demultiplexing said wavelength multiplexed signal to a node-through signal and a signal to be subjected to processing on the basis of said wavelength band and said wavelength,
a third matrix switch for receiving input of said node-through signal to conduct path switching, and
a third optical multiplexer for multiplexing an output of said third matrix switch and an output of said first optical multiplexer.

12. The cross connecting device as set forth in claim 3, further comprising:
an optical-electrical transducer for receiving said signal of each wavelength which is branched from at least one of branch ports of said second matrix switch to convert the signal to an electric signal,
a client interface for transmitting the electric signal converted by said optical-electrical transducer to a client, as well as receiving an electric signal from said client,
an electrical-optical transducer for converting the electric signal received by said client interface into an optical signal and transmitting the converted signal to at least one of the insertion ports of said second matrix switch,
a third optical demultiplexer for demultiplexing said wavelength multiplexed signal to a node-through signal and a signal to be subjected to processing on the basis of said wavelength band and said wavelength,
a third matrix switch for receiving input of said node-through signal to conduct path switching, and
a third optical multiplexer for multiplexing an output of said third matrix switch and an output of said first optical multiplexer.

13. The cross connecting device as set forth in claim 3, wherein
said second optical demultiplexer is formed of a variable-wavelength filter.

14. The cross connecting device as set forth in claim 3, wherein
said first optical demultiplexer is structured such that said wavelength band satisfies that a wavelength band constituent wavelength interval≧a wavelength interval between adjacent wavelength bands×the number of wavelength bands, and said second optical demultiplexer is formed of a wavelength band pass filter having a transmission band width which is equivalent to said constituent wavelength interval.

15. The cross connecting device as set forth in claim 3, further comprising:
an optical-electrical transducer provided at a stage succeeding to said second optical demultiplexer, and
an electrical-optical transducer provided at a stage succeeding to said second matrix switch, wherein
said second matrix switch is formed of an electric switch,
said first optical demultiplexer is structured such that said wavelength band satisfies that a wavelength band constituent wavelength interval≧a wavelength interval between adjacent wavelength bands×the number of wavelength bands, and said second optical demultiplexer is formed of a wavelength band pass filter having a transmission band width which is equivalent to said constituent wavelength interval.

16. The cross connecting device as set forth in claim 4, further comprising
a client interface for receiving an electric signal branched from at least one of branch ports of said second matrix switch and transmitting the same to a client, as well as receiving an electric signal from said client and transmitting the same to at least one of the insertion ports of said second matrix switch, wherein
said first optical demultiplexer is structured such that said wavelength band satisfies that a wavelength band constituent wavelength interval≧a wavelength interval between adjacent wavelength bands×the number of wavelength bands, and said second optical demultiplexer is formed of a wavelength band pass filter having a transmission band width which is equivalent to said constituent wavelength interval.

17. The cross connecting device as set forth in claim 3, further comprising:
an optical-electrical transducer for receiving said signal of each wavelength which is branched from at least one of branch ports of said second matrix switch to convert the signal to an electric signal,
a client interface for transmitting the electric signal converted by said optical-electrical transducer to a client, as well as receiving an electric signal from said client, and
an electrical-optical transducer for converting the electric signal received by said client interface into an optical signal and transmitting the converted signal to at least one of the insertion ports of said second matrix switch, wherein
said first optical demultiplexer is structured such that said wavelength band satisfies that a wavelength band constituent wavelength interval≧a wavelength interval between adjacent wavelength bands×the number of wavelength bands, and said second optical demultiplexer is formed of a wavelength band pass filter having a transmission band width which is equivalent to said constituent wavelength interval.

18. The cross connecting device as set forth in claim 3, further comprising:
a third optical demultiplexer for demultiplexing said wavelength multiplexed signal to a node-through signal and a signal to be subjected to processing on the basis of said wavelength band and said wavelength,
a third matrix switch for receiving input of said node-through signal to conduct path switching, and
a third optical multiplexer for multiplexing an output of said third matrix switch and an output of said first optical multiplexer, wherein
said first optical demultiplexer is structured such that said wavelength band satisfies that a wavelength band constituent wavelength interval≧a wavelength interval between adjacent wavelength bands×the number of wavelength bands, and said second optical demultiplexer is formed of a wavelength band pass filter having a transmission band width which is equivalent to said constituent wavelength interval.

19. The cross connecting device as set forth in claim 3, wherein
said first optical demultiplexer is formed such that said wavelength band has an equal interval and said second optical demultiplexer is formed of such a filter making use of light diffraction as is represented by an arrayed-waveguide gratings whose central wavelength interval of a transmission band coincides with the interval of said wavelength band constituent wavelength and whose free spectral range coincides with the interval of said wavelength band.

20. The cross connecting device as set forth in claim 3, further comprising:
an optical-electrical transducer provided at a stage succeeding to said second optical demultiplexer, and
an electrical-optical transducer provided at a stage succeeding to said second matrix switch, wherein
said second matrix switch is formed of an electric switch, and
said first optical demultiplexer is formed such that said wavelength band has an equal interval and said second optical demultiplexer is formed of such a filter making use of light diffraction as is represented by arrayed-waveguide gratings whose central wavelength interval of a transmission band coincides with the interval of said wavelength band constituent wavelength and whose free spectral range coincides with the interval of said wavelength band.

21. The cross connecting device as set forth in claim 4, further comprising
a client interface for receiving an electric signal branched from at least one of branch ports of said second matrix switch and transmitting the same to a client, as well as receiving an electric signal from said client and transmitting the same to at least one of the insertion ports of said second matrix switch, wherein
said first optical demultiplexer is formed such that said wavelength band has an equal interval and said second optical demultiplexer is formed of such a filter making use of light diffraction as is represented by arrayed-waveguide gratings whose central wavelength interval of a transmission band coincides with the interval of said wavelength band constituent wavelength and whose free spectral range coincides with the interval of said wavelength band.

22. The cross connecting device as set forth in claim 3, further comprising:
an optical-electrical transducer for receiving said signal of each wavelength which is branched from at least one of branch ports of said second matrix switch to convert the signal to an electric signal,
a client interface for transmitting the electric signal converted by said optical-electrical transducer to a client, as well as receiving an electric signal from said client, and
an electrical-optical transducer for converting the electric signal received by said client interface into an optical signal and transmitting the converted signal to at least one of the insertion ports of said second matrix switch, wherein
said first optical demultiplexer is formed such that said wavelength band has an equal interval and said second optical demultiplexer is formed of such a filter making use of light diffraction as is represented by arrayed-waveguide gratings whose central wavelength interval of a transmission band coincides with the interval of said wavelength band constituent wavelength and whose free spectral range coincides with the interval of said wavelength band.

23. The cross connecting device as set forth in claim 3, further comprising:
a third optical demultiplexer for demultiplexing said wavelength multiplexed signal to a node-through signal and a signal to be subjected to processing on the basis of said wavelength band and said wavelength,
a third matrix switch for receiving input of said node-through signal to conduct path switching, and
a third optical multiplexer for multiplexing an output of said third matrix switch and an output of said first optical multiplexer, wherein
said first optical demultiplexer is formed such that said wavelength band has an equal interval and said second optical demultiplexer is formed of such a filter making use of light diffraction as is represented by arrayed-waveguide gratings whose central wavelength interval of a transmission band coincides with the interval of said wavelength band constituent wavelength and whose free spectral range coincides with the interval of said wavelength band.

24. An optical communication system, wherein
a cross connecting device is applied to a node device,
said cross connecting device comprising:
a first matrix switch for conducting path change of an applied wavelength multiplexed signal on the basis of a plurality of wavelength bands,
a second matrix switch for switching a path of a part of switch outputs from the first matrix switch on a wavelength basis, and
an optical demultiplexer provided on a link connecting said first and second matrix switches and capable of demultiplexing an arbitrary wavelength band.

25. An optical communication system, wherein
a cross connecting device in the optical communication system employing a wavelength multiplex transmission method of transmitting an optical signal with wavelengths multiplexed is applied to a node device,
said cross connecting device comprising:
a first optical demultiplexer for demultiplexing said wavelength multiplexed signal to a wavelength band composed of a plurality of wavelengths,
a first matrix switch for receiving input of said wavelength band demultiplexed by said first optical demultiplexer to conduct path switching,
a first optical multiplexer for multiplexing outputs of said first matrix switch and outputting the multiplexed signal,
a second optical demultiplexer for receiving said wavelength band of an arbitrary band zone branched from at least one of branch ports of said first matrix switch and demultiplexing the band to a signal of each wavelength,
a second matrix switch for receiving input of said signal of each wavelength demultiplexed by said second optical demultiplexer to conduct path switching, and
a second optical multiplexer for multiplexing outputs of said second matrix switch and sending out the multiplexed signal to at least one of insertion ports of said first matrix switch.
